(19) United States
(12) Patent Application Publication
(10) Pub. No.: US 2012/0256948 A1
(43) Pub. Date: Oct. 11, 2012

(54) METHOD AND SYSTEM FOR RENDERING IMAGES IN SCENES

(75) Inventors: Jorel Fermin, Watertown, MA (US); Eugene Hsu, Somerville, MA (US); Nathaniel P. Woods, Lexington, MA (US)

(73) Assignee: Vistaprint Technologies Limited

(21) Appl. No.: 13/084,550

(22) Filed: Apr. 11, 2011

(51) Int. Cl. G09G 5/377

(52) U.S. Cl. 345/629

(57) ABSTRACT

Systems and methods are described for generating and using a flexible scene framework to render dynamically-generated content within contextual scenes.

As consumers have become increasingly comfortable with online shopping, many retailers of products offer a retail presence to take advantage of the ecommerce marketplace. Some online retailers offer products that can be customized or personalized based on user-selected choices or inputs, and/or customer-specific information. For example, the www.vistaprint.com web site offers printed, engraved, and embroidered products that can be customized by the customer to include text and images selected and/or uploaded by the customer. For such online retailers, many of the images on the web site and on marketing materials are devoted to showing content on products, and products in context.

For example, a preview of a customer's selected design personalized with information entered by the customer may be presented to a customer selecting customizations and/or personalizing it with user-entered text and/or uploaded images. Besides merely showing the design imprinted, engraved, or embroidered on the product, a good preview might also show the product in context, for example within a larger scene. Previews of the customized products assist the customer in determining where the content is going to be placed, how large the product is, and/or how the product might fit their needs.

Contextual scenes can be created as composite images, for example using Adobe® Photoshop. Photoshop can be used to layer images on top of one another, rotate, warp, and blend images. However, when the composite image is saved using Photoshop, it is saved as a static image and cannot accept dynamically generated content. Online retailers who wish to show images with dynamically generated content, for example for showing images of products personalized with customer information, need to be able to generate customized images and place them within a larger scene on the fly without significant delay in order to prevent or reduce customer drop-off during the browsing process.

In the past, in order to generate previews in context, each context image was implemented as a separate class and had its own unique and static way of drawing itself. Each context image is independently coded in a browser-renderable language (such as HTML, DHTML, etc.), and then dynamically-generated content is rendered by the browser together with the context image. Generating browser-renderable context images in this way requires significant coding time.

Accordingly, it would be desirable to have a better technique for quickly generating dynamically-generated content within contextual scenes.

### BRIEF DESCRIPTION OF THE DRAWINGS

FIG. 1 illustrates examples of dynamically generated content incorporated within contextual scenes;

FIG. 2 is a block diagram of FIG. 3 diagrammatically illustrates a perspective warp;

FIG. 4 diagrammatically illustrates a smooth warp;

FIG. 5 is a flowchart illustrating an exemplary method for generating;

FIG. 6 illustrates a representation of a composition tree;

FIG. 7 diagrammatically illustrates a flattening operation; and

FIG. 8 is an exemplary computing environment in which embodiments of the invention may operate.

### SUMMARY

Embodiments of the present invention includes systems and methods for generating and using a flexible scene framework to render dynamically-generated content within contextual scenes.

In an embodiment, a method for generating scenes with dynamically-generated content for display includes providing to the scene framework engine one or more injectables to be rendered in a composite scene, providing to a scene framework engine one or more scene description files according to the scene-rendering language, the scene description file identifying one or more resources and describing the layering, blending, and specific image manipulations that should be applied to one or more of the injectables or resources when injecting the injectables into the resources, wherein the scene framework engine is configured to layer and manipulate the one or more resources and/or the one or more injectables as described in the one or more scene description files.

In another embodiment, a system for generating and using a flexible scene framework to render dynamically-generated content within contextual scenes is provided.

### DETAILED DESCRIPTION

Embodiments of the present invention utilize a novel scene framework to render dynamically-generated content within contextual scenes.

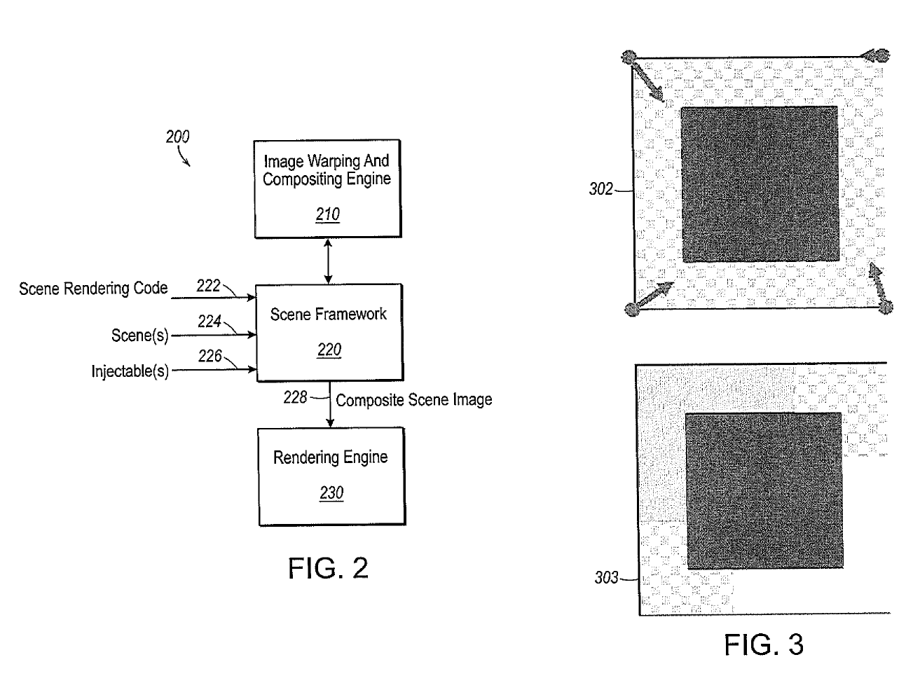

FIG. 2 is a block diagram of a system 200 for generating scenes with dynamically-generated content for display in a browser. As illustrated, the system 200 includes an image warping and compositing engine 210, a scene framework engine 220, and a rendering engine 230.

The scene framework 220 receives or obtains scene rendering code 222, one or more scene image(s) 224, and one or more image(s)/text/document(s) (hereinafter called “injectable(s)”) 226 to place within a generated scene. The scene framework 220 generates an image 228 containing the injectable(s) 224 composited into the received scene(s) 224 according to the scene rendering code 222. The scene rendering code 222 is implemented using an intuitive language (for example, in an XML format), and specifies the warping and compositing functionality to be performed on the injectable(s) 226 (and possibly the scene(s) 224) when generating the composite image 228. A rendering engine 230 receives the composite image 228 and renders it in a user's browser.

The scene framework 220 is a graphical composition framework that allows injection of documents, images, text, logos, uploads, etc., into a scene (which may be generated by layering one or more images). All layers of the composite image may be independently warped, and additional layering, coloring, transparency, and other inter-layer functions are provided. The scene framework 220 includes an engine which executes, interprets, consumes, or otherwise processes the scene rendering code 222 using the specified scene(s) 222 and injectable(s) 224.

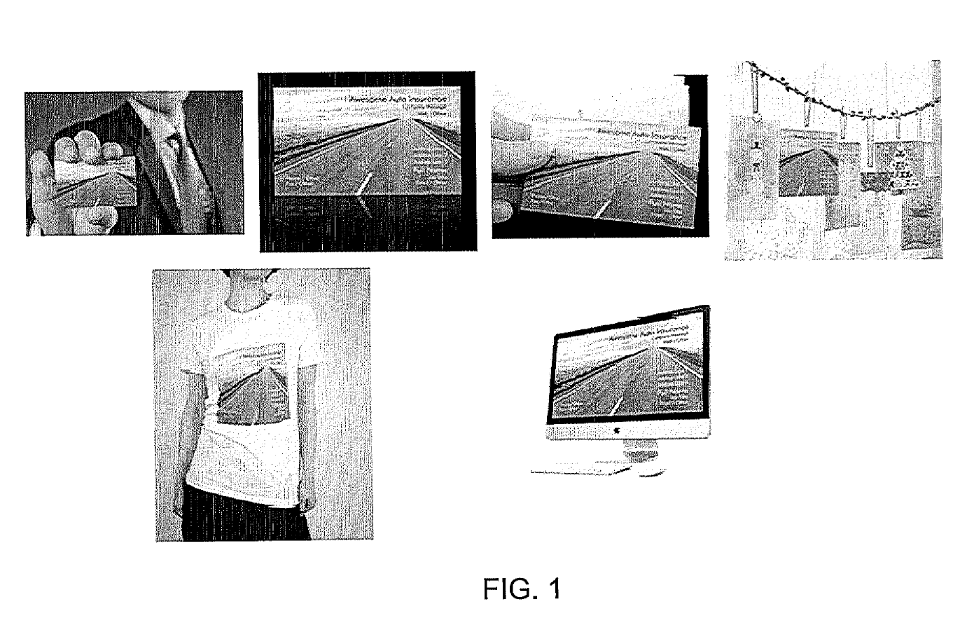

At a high level, the Framework 220 is a scene rendering technology for showing customized products in context. A generated preview of the customized product itself may be transformed in various ways, and placed inside a larger scene. Examples of such generated previews implemented in contextual scenes are illustrated in FIG. 1, showing a business card in a variety of different scenes.

Scenes can be chained or cascaded, so that one scene can be part of another scene and so forth. A scene may incorporate more than one placeholder location for an injectable scene element such as the business card in each of the composite scenes in FIG. 1.

In embodiment of the present invention, this is achieved by decorating rendered Previews with additional image assets. Previously, generating scenes incorporating Previews involved substantial development effort. This process has been vastly simplified thanks to the two key components of the scene framework:
The warping and compositing engine 210 which enables flexible and seamless positioning of documents within an image
An intuitive XML format for implementing the scene rendering code 222 that allows designers to quickly prototype and deploy scenes with minimal interaction with software engineers and Scene Framework 220 for processing the scene rendering code 222.

Turning first to the Image Warping and Compositing Engine 210, this component performs the image transformations and compositing. Image warping and compositing are two ways to assemble new images from existing ones. Historically, they have been achieved using a variety of techniques which yield inconsistent results. Furthermore, the ad hoc nature of these techniques added unnecessary complexity to the code. The novel warping and compositing framework provides image warping and compositing functionality to render scenes with dynamically injected content.

Image warping is the act of taking a source image and moving its pixels onto a target image. A number of typical image operations can be described in terms of image warping. For instance, a simple scaling operation (e.g., reducing a large photo to a thumbnail) is an image warp. More sophisticated warps may involve nonlinear effects such as wrapping an image around a cylinder or sphere.

The Image Warping And Compositing Engine 210 performs image warping and transformations. In an embodiment, the Image Warping And Compositing Engine 210 provides a class to perform warping, herein referred to as the “Warper” class. The Warper class includes a static method Apply(Bitmap target, Bitmap source, IWarp warp). This method takes two bitmaps and an “IWarp” object which specifies the warp itself.

In one embodiment, the Warper class implements inverse warping with bilinear sampling. The Warper iterates over each pixel in the target image, figures out the location in the source image it should come from, and copies the pixel color over. If the location happens to be between pixels in the source image (as is often the case) it will linearly interpolate the colors of the neighboring pixels to get the result.

There are various types of warps. The simplest warp is known as the perspective warp (implemented as PerspectiveWarp). The PerspectiveWarp allows the user to move the corners of an image and warp the image accordingly. FIG. 3 shows the operation of a PerspectiveWarp. The top image is the original image notated by arrows indicating the movement of the corners. A class can be implemented, for example the “PerspectiveWarp” class, to allow users to place the corners of a source image at specified locations in a target image. For instance, suppose we wanted to warp the image 302 into the image 303 as shown in FIG. 3. The first step is to determine the coordinates in the image 302 corresponding to where the corners of the logo should go. These coordinates are used to initialize a perspective warp (in the order upper left, upper right, lower left, lower right). Applying the warp and compositing the target onto the background yields the image 303.

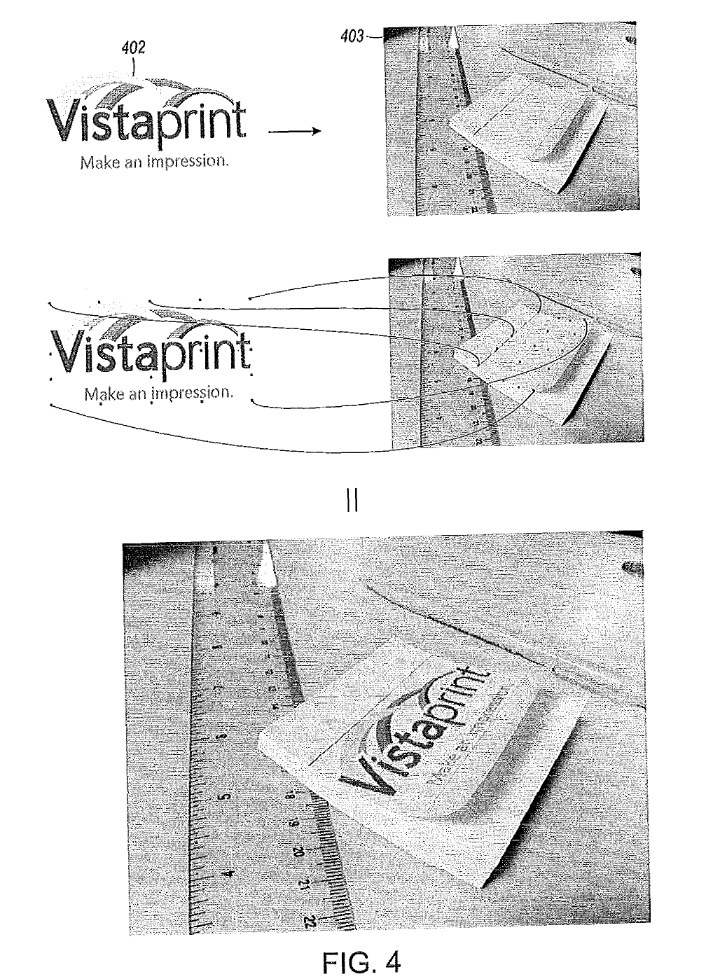

Another type of warp is the “smooth” warp. The smooth warp is the most general type of warp. It is meant for cases which defy simple mathematical definition. For example, suppose we want to warp the logo 402 onto a scene 403 of a slightly curved sticky note, as shown in FIG. 4. This warp can be specified by providing coordinates texFeatures on the logo and their corresponding and desired locations imgFeatures on the background image.
var[,] texFeatures=new double[,] {{0.00, 0.00}, {0.25, 0.00}, {0.50, 0.00}, {0.75, 0.00}, {1.00, 0.00}, {0.00, 0.50}, {0.25, 0.50}, {0.50, 0.50}, {0.75, 0.50}, {1.00, 0.50}, {0.00, 0.75}, {0.50, 0.75}, {1.00, 0.75}, {0.00, 1.00}, {0.25, 1.00}, {0.50, 1.00}, {0.75, 1.00}, {1.00, 1.00}};
var[,] imgFeatures=new double[,] {{223.0, 276.0}, {271.0, 235.0}, {310.0, 203.0}, {346.0, 173.4{378.0, 145.0}, {286.0, 315.0}, {330.0, 270.0}, {368.0, 230.0}, {401.0, 194.0},{431.0, 162.0}, {326.0, 334.0}, {401.0, 241.0}, {459.0, 169.0}, {363.0, 341.0}, {402.0, 289.0}, {438.0, 244.0}, {469.0, 203.0}, {495.0, 168.0}};

Notice that the texFeatures are specified in normalized texture coordinates: [0,0] corresponds to the upper left and [1,1] corresponds to the lower right. The imgFeatures are given as standard pixel coordinates. The warp is defined as:

var warp=new Smooth Warp(imgFeatures, texFeatures);

It is possible to simulate other types of warps using a smooth warp given enough point correspondences. However, using the appropriate type of warp when available (e.g., perspective or cylinder) will typically yield better results with less user input.

All of the aforementioned warps implement the IWarp interface. The singular goal of an IWarp is to provide, for any rectangle in the target image, a corresponding set of texture coordinates in the source image to sample color information using bilinear interpolation. To implement a new warp, see the source code for examples (PerspectiveWarp is the simplest).

The Image Warping and Compositing Engine 210 also performs image compositing. Image compositing is the act of combining multiple images into a single image. The Image Warping and Compositing Engine 210 provides similar compositing functionality to common image manipulation switch, such as Adobe® Photoshop. For example, the following layering functionality is supported. Compositor duplicates these layer blending modes: Add, Darken, Difference, Exclusion, Lighten, Multiply, Normal, Overlay, Screen, Subtract.

Turning now to the Scene Framework 220, the scene rendering code adheres to a predefined format using a predefined scene-rendering language. In an embodiment, the scene rendering language utilizes an intuitive HTML- or XML-like language format that allows a user to specify image warping and compositing functions to describe how the image(s) are to be composited. In an embodiment, the Framework 220 utilizes an easy-to-understand XML notation for expressing how image elements should be composited to create the visually convincing renderings. The notation is simple enough that a creative designer can put together a sandwich that layers together imagery, documents, and transformation.

In an embodiment, scenes 224 are XML documents that reside in a web tree along with their corresponding image resources. A basic scene might consist of three scene files.

/vp/scenes/example/reflection.xml
/vp/scenes/example/mask.png
/vp/scenes/example/back.png

The scene-rendering code 222 is preferably an XML file implemented using the scene-rendering language and describes how these image resources are combined with a document (i.e., an injectable) to create the composite scene image 228. In an embodiment, configurable scenes have two sections: a <Warps> section that defines geometric transformations (as described in more detail below), and a <Composite> section that defines how to assemble the document itself and other images.

Below is an example scene file:

```
<Scene>
  <Warps>
  <PerspectiveWarp id=“placement” width=“610” height=“354”>
```

<Mapping sourcex=“0.0” sourcey=“0.0” targetx=“267”
targety=“289” />
<Mapping sourcex=“1.0” sourcey=“0.0” targetx=“556”
targety=“289” />
<Mapping sourcex=“0.0” sourcey=“1.0” targetx=“267”
targety=“122” />
<Mapping sourcex=“1.0” sourcey=“1.0” targetx=“556”
targety=“122” />

```
  </PerspectiveWarp>
  <PerspectiveWarp id=“reflection” width=“610” height=“354”>
```

<Mapping sourcex=“0.0” sourcey=“0.0” targetx=“267”
targety=“289” />
<Mapping sourcex=“1.0” sourcey=“0.0” targetx=“556”
targety=“289” />
<Mapping sourcex=“0.0” sourcey=“1.0” targetx=“267”
targety=“456” />
<Mapping sourcex=“1.0” sourcey=“1.0” targetx=“556”
targety=“456” />

```
  </PerspectiveWarp>
  </Warps>
  Composite width=“610” height=“354” depth=“0”>
  <Document warp=“placement” depth=“0/>
  <Composite width=“610” height=“354” mode=“multiply” depth=“50”>
```

<Image width=“610” height=“354” src=“mask.png” mode=“mask”
depth=“0” />
<Document warp=“reflection” depth=“0” />

```
  </Composite>
  <Image width=“610” height=“354” src=“background.png”
  depth=“100” />
  </Composite>
</Scene>
```

The simplest scene 224 is an image (i.e., “image.jpg”) itself.

```
<Scene>
  <Composite width=“100” height=“100”>
  <Image src=“image.jpg” width=“100” height=“100” />
  </Composite>
</Scene>
```

All elements have width and heights defined.

Scenes allow users to composite them as follows:

```
<Scene>
  <Composite width=“100” height=“100”>
  <Document width=“100” height=“100” depth=“0”/>
  <Image src=“image.jpg” width=“100” height=“100” depth=“100” />
  </Composite>
</Scene>
```

This scene combines a scene image “image.jpg” with an injectable “Document”. In this example, a depth attribute has been added to the primitives to define layer ordering. Smaller depths indicate “closer” layers, so in this example the image “image.jpg” is “behind” the document “Document”.

Composites can also be nested. An internal composite is assembled and then treated exactly like it is an image. This means that any internal depth parameters are ignored when assembling the parent composite.

```
<Scene>
  <Composite width=“100” height=“100”>
  <Document width=“100” height=“100” depth=“0”/>
  <Composite width=“100” height=“100” depth=“50”>
```

<Image src=“image2.png” width=“100” height=“100”
depth=“123908123” />
<Image src=“image3.png” width=“100” height=“100”
depth=“439087123”/>

```
  </Composite>
  <Image src=“image.jpg” width=“100” height=“100”
  depth=“100” />
  </Composite>
</Scene>
```

In the above example, the nested composite is treated as any other 100-by-100 image and is assembled with depth 50.

Warping is defined as any operation that changes the geometry of the image. It can range from a simple resizing operation to a highly complex and nonlinear deformation. Each warp is identified by a name and specifies an output width and height.

```
<RectangleWarp id=“icon” width=“100” height=“100”>
  <Mapping sourcex=“0.0” sourcey=“0.0” targetx=“10” targety=“90” />
  <Mapping sourcex=“1.0” sourcey=“1.0” targetx=“20” targety=“80” />
</RectangleWarp>
```

As shown above, the rectangle warp requires the user to specify the desired placement of the lower-left (0,0) and upper-right and upper-right (1,1) corners of the source image. It simply places the source image, whatever size it may be, as a 10-by-10 icon in the lower-left corner of the 100-by-100 target canvas (leaving all other pixels transparent). The exact same effect can be achieved using a perspective warp.

```
<PerspectiveWarp id=“icon2” width=“100” height=“100”>
  <Mapping sourcex=“0.0” sourcey=“0.0” targetx=“10” targety=“90” />
  <Mapping sourcex=“1.0” sourcey=“0.0” targetx=“20” targety=“90” />
  <Mapping sourcex=“0.0” sourcey=“1.0” targetx=“10” targety=“80” />
  <Mapping sourcex=“1.0” sourcey=“1.0” targetx=“20” targety=“80” />
</PerspectiveWarp>
```

In contrast to the rectangle warp, the perspective warp requires the specification of all four corners of the source image. The above example is identical to a rectangle warp. More generally, a perspective warp allows users to “tilt the image away from the camera”.

```
<Scene>
  <Warps>
  <PerspectiveWarp id=“icon” width=“100” height=“100”>
```

<Mapping sourcex=“0.0” sourcey=“0.0” targetx=“10”
targety=“90” />
<Mapping sourcex=“1.0” sourcey=“0.0” targetx=“20”
targety=“90” />
<Mapping sourcex=“0.0” sourcey=“1.0” targetx=“10”
targety=“80” />
<Mapping sourcex=“1.0” sourcey=“1.0” targetx=“20”
targety=“80” />

```
  </PerspectiveWarp>
  </Warps>
  <Composite width=“100” height=“100”>
  <Document warp=“icon” depth=“0”/>
  <Image src=“image.jpg” width=“100” height=“100” depth=“100” />
  </Composite>
</Scene>
```

In the above example, the document in the Composite now references the perspective warp by name “PerspectiveWarp”. The reference makes it unnecessary to define the width and height of the document. Instead, the width and height comes from the warp. As before, the sizes must be consistent (e.g., the warp can't have a different size as the composite) or it will result in a failure. In general, warps can be applied to both the document and image primitives as well as on nested composites.

The smooth warp follows the same template as the perspective warp but allows for more general deformations.

```
<SmoothWarp id=“blah” width=“100” height=“100”>
  <Mapping sourcex=“0.0” sourcey=“0.0” targetx=“10” targety=“90” />
  <Mapping sourcex=“1.0” sourcey=“0.0” targetx=“20” targety=“90” />
  <Mapping sourcex=“0.0” sourcey=“1.0” targetx=“10” targety=“90” />
  <Mapping sourcex=“1.0” sourcey=“1.0” targetx=“20” targety=“80” />
  <Mapping sourcex=“0.5” sourcey=“0.5” targetx=“17” targety=“87” />
</SmoothWarp>
```

Notice that this looks exactly the same as the perspective warp, except it also specifies the desired location of the source image center (0.5,0.5). This smooth warp allows an arbitrary number of mappings and, unlike the perspective warp, does not require the corners to be specified.

In general, the warp=attribute may be applied wherever width=and height=are used, except for the top level <Scene>, and so long as all sizes are consistent.

To extend the capabilities of composites, scenes also allow several blending modes: Add, Darken, Difference, Exclusion, Lighten, Multiply, Normal, Overlay, Screen, Subtract. These are applied from background to foreground: the bottom/deepest layer/primitive is composited with the layer/primitive immediately above it, and the process is repeated until the image is flat. Blending modes in nested composites are not visible from the parent composite.

The Scene Framework 220 also supports a Mask mode, as in the following example:

```
<Composite width=“610” height=“354” depth=“0”>
  <Document warp=“placement” depth=“0”/>
  <Composite width=“610” height=“354” mode=“multiply” depth=“50”>
  <Image width=“610” height=“354” src=“mask.png” mode=“mask”
  depth=“0” />
  <Document warp=“reflection” depth=“0” />
  </Composite>
  <Image width=“610” height=“354” src=“background.png”
  depth=“100” />
</Composite>
```

The Mask mode applies the alpha channel of the image to the layers below it (while ignoring the color channels). Notice that the above example applies the mask in a nested composite. This is to avoid also masking the background image (again, since blending modes are not passed through).

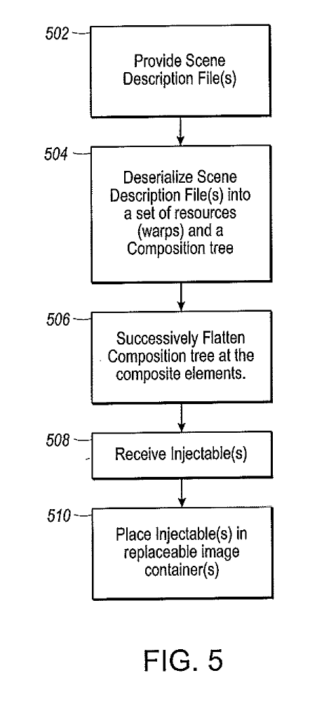

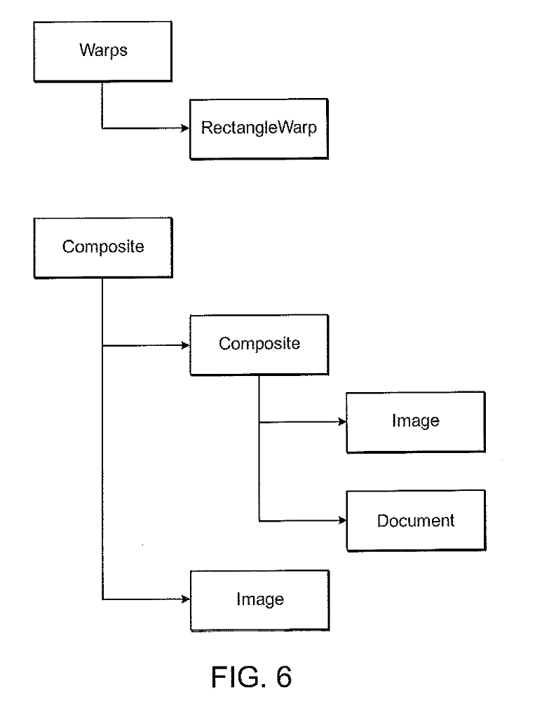

FIG. 5 is a flowchart exemplifying a method of generating scenes with dynamically-generated content for display. As illustrated in FIG. 5, each scene is described in a scene description file 224 (e.g., using the XML definitions described above) according to the scene-rendering language (step 502). The scene description file 224 describes the layering, blending, and specific image manipulations that should be applied when injecting injectables 226. The scene description file 224 is deserialized by the Scene Framework 220 into a set of resources (warps) and a Composition tree (step 504). The composition tree plus resources is the internal representation of the scene. For example, a scene description file as follows may be decomposed into the tree shown in FIG. 6.

<Scene>

<Warps>

<RectangleWarp id=“blah” width=“601” height=“817”>

<Mapping sourcex=“0.49962077” sourcey=“0.00459265”
targetx=“5” targety=“64” />
<Mapping sourcex=“0.96038339” sourcey=“0.72623802”
targetx=“592” targety=“812” />

</RectangleWarp>

</Warps>
<Composite width=“601” height=“817”>

<Composite width=“601” height=“817” depth=“0”>

<Image src=“oldm.png” mode=“mask” depth=“0” />
<Document height=“1200” warp=“blah” depth=“2” />

</Composite>
<Image src=“oldf.png” depth=“1900” />

</Composite>

</Scene>

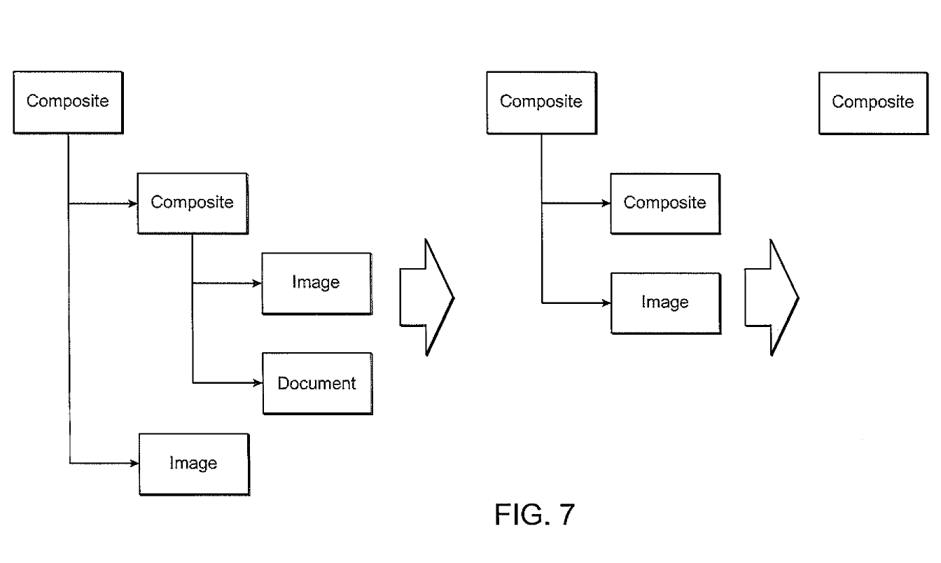

The composition tree is successively flattened at the composite elements (in one embodiment, in a depth first manner) (step 506). Each element is ordered and merged with the other elements, as illustrated in FIG. 7. Each merge even applies the appropriate bending mode and warping. The output of step 506 is a static image (i.e., the scene into which the injectable is to be injected).

A set of injectables (e.g., document, upload, logo, etc.) is received by the Scene Framework 220 (step 508). The injectable(s) are placed in corresponding “IReplaceableImageContainer” (step 510).

In an embodiment, the scene rendering code 222 is styled within a predefined scene-rendering code template, such as the following:

public void MakeAScene(Bitmap bitmap, Rectangle rect)
{

var sceneFactory = new SceneFactory( );
var scene =
SceneFactory.LoadScene(@\\devyourhost\Scenes\scene.xml);
var proxy = new ReplaceableImageContainer( );
var lockedBitmap = new BitmapDataLockedSimpleBitmap(bitmap,
rect, ImageLockMode.ReadWrite);
scene.Render(proxy, lockedBitmap);
// Now you can do whatever you want with the locked bitmap

}
private class ReplaceableImageContainer : IReplaceableImageContainer
{

// Your Code Here!!!

}

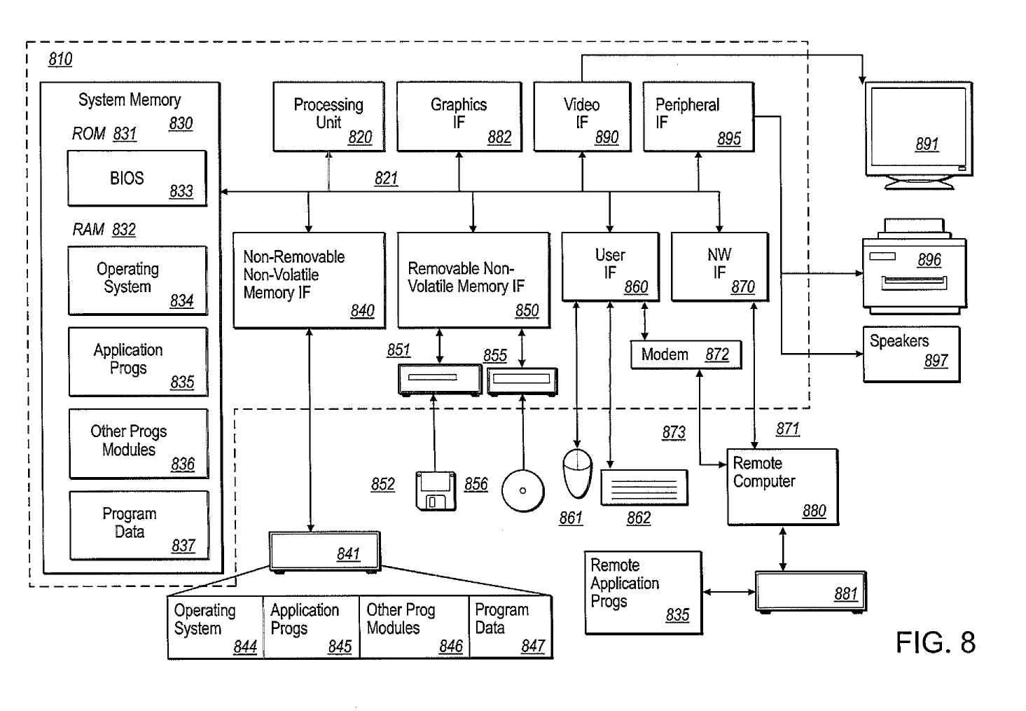

FIG. 8 illustrates a computer system 810 that may be used to implement any of the servers and computer systems discussed herein, including the Image Warping and Composite Engine 210, the Scene Framework Engine 220, the Renderer 230, any client requesting services of the Framework 220, and any server on which any of the components 210, 220, 230 are hosted. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 810. Computer storage media typically embodies computer readable instructions, data structures, program modules or other data.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 840 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8 provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 890.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

1. A method for generating scenes with dynamically-generated content for display, comprising:
selecting one or more injectable scene elements;
selecting one or more scene images at least one of which comprises one or more placeholder locations for placement of injectable scene elements,
selecting one or more scene descriptions comprising computer-readable scene rendering instructions for compositing at least one of the scene images and at least one of the injectable scene element and for performing at least one image transformation on at least one of the at least one scene image and the at least one injectable scene element;
processing the selected scene descriptions, by one or more processors, to inject respective ones of the selected injectable scene elements into corresponding placeholder locations in one or more respective scene images specified in the selected scene descriptions and to perform one or more image transformations and compositing of the selected injectable scene elements and the specified scene images to generate a composite scene image depicting the selected injectable scene elements in a scene.

2. The method of claim 1, wherein the scene description comprises a warping specification which defines one or more geometric transformation that changes the geometry of an image, and a compositing specification which defines in what order to layer the specified scene images and the selected injectable scene elements and specifies application of one or more of the defined geometric transformations to one or more of the specified scene images and selected injectable scene elements.

3. The method of claim 2, wherein the compositing specification specifies a composition tree comprising a plurality of individual composite descriptions, the method further comprising:
processing each of the plurality of individual composite descriptions to generate a respective individual flattened composite image prior to processing a composite description which includes an individual composite description.

4. The method of claim 3, wherein at least some of the individual composite descriptions are nested at different levels of the compositing tree.

5. The method of claim 4, further comprising:
generating and flattening the respective individual composite according to a deepest depth first.

6. The method of claim 2, wherein the warping specification defines at least a rectangular warp.

7. The method of claim 2, wherein the warping specification defines at least a perspective warp.

8. The method of claim 2, wherein the warping specification defines at least a smooth warp.

9. The method of claim 1, compositing the received one or more of the selected injectable scene elements on different layers than the specified one or more scene images.

10. The method of claim 1, further comprising:
rendering the composite scene image on a display screen.

11. Non-transitory computer readable storage tangibly embodying program instructions which, when executed by a computer, implement the method of claim 1.

12. A system for generating a personalized scene, comprising:
computer-readable storage retaining one or more injectable scene elements, one or more scene images at least one of which comprises one or more placeholder locations for placement of injectable scene elements, and one or more scene descriptions comprising computer-readable scene rendering instructions for compositing at least one of the scene images and at least one of the injectable scene element and for performing at least one image transformation on at least one of the at least one scene image and the at least one injectable scene element;
one or more processors configured to process at least one of the scene descriptions to thereby inject respective ones of the selected injectable scene elements into corresponding placeholder locations in one or more respective scene images specified in the selected scene descriptions and to perform one or more image transformations and compositing of the selected injectable scene elements and the specified scene images to generate a composite scene image depicting the selected injectable scene elements in a scene.

13. The system of claim 12, wherein the scene description comprises:
a warping specification which defines one or more geometric transformations that change the geometry of an image, and
a compositing specification which defines in what order to layer the specified scene images and the selected injectable scene elements and specifies application of one or more of the defined geometric transformations to one or more of the specified scene images and selected injectable scene elements.

14. The system of claim 13, wherein the compositing specification specifies a composition tree comprising a plurality of individual composite descriptions, and wherein the one or more processors are configured to process and flatten each of the plurality of individual composite descriptions to generate a respective individual composite image, wherein at least one of the respective individual composite images is nested within another individual composite description.

15. The system of claim 14, wherein at least some of the individual composite descriptions are nested at different levels of the compositing tree.

16. The system of claim 15, wherein the one or more processors are configured to generate and flatten the respective individual composite according to a deepest depth first.

17. The system of claim 13, wherein the warping specification defines at least a rectangular warp.

18. The system of claim 13, wherein the warping specification defines at least a perspective warp.

19. The system of claim 13, wherein the warping specification defines at least a smooth warp.

20. The system of claim 12, further comprising:
a rendering engine which renders the composite scene image on a display screen.
